(19) United States
(12) Patent Application Publication
(10) Pub. No.: US 2017/0161555 A1
(43) Pub. Date: Jun. 8, 2017

(54) SYSTEM AND METHOD FOR IMPROVED VIRTUAL REALITY USER INTERACTION UTILIZING DEEP-LEARNING

(71) Applicant: Pilot AI Labs, Inc., Sunnyvale, CA (US)

(72) Inventors: Ankit Kumar, San Diego, CA (US); Brian Pierce, Santa Clara, CA (US); Elliot English, Stanford, CA (US); Jonathan Su, San Jose, CA (US)

(73) Assignee: Pilot AI Labs, Inc., Sunnyvale, CA (US)

(21) Appl. No.: 15/369,744

(22) Filed: Dec. 5, 2016

Related U.S. Application Data
(60) Provisional application No. 62/263,607, filed on Dec. 4, 2015.

(51) Int. Cl. G06K 9/00; G06F 3/01; G06K 9/62

(52) U.S. Cl. CPC G06K 9/00355; G06K 9/6254; G06K 9/6261; G06F 3/017

(57) ABSTRACT

According to various embodiments, a method for gesture recognition using a neural network is provided. The method comprises a training mode and an inference mode. In the training mode, the method includes: passing a dataset into the neural network; and training the neural network to recognize the fingers of a training user and a gesture of interest, wherein the neural network includes a convolution-nonlinearity step and a recurrent step. In the inference mode, the method includes: passing a series of images into the neural network, wherein the series of image is a virtual reality feed that includes the hands of a VR user; and recognizing the fingers of the VR user and gestures of interests from the series of images.

### CROSS REFERENCE TO RELATED APPLICATIONS

This application claims priority under 35 U.S.C. §119(e) to U.S. Provisional Application No. 62/263,607, filed Dec. 4, 2015, entitled SYSTEM AND METHOD FOR IMPROVED VIRTUAL REALITY USER INTERACTION UTILIZING DEEP-LEARNING, the contents of which are hereby incorporated by reference.

### TECHNICAL FIELD

The present disclosure relates generally to machine learning algorithms, and more specifically to virtual reality applications using machine learning algorithms.

### BACKGROUND

Virtual reality, or VR, has become more and more popular. VR systems allow a user to experience a digital world and to control certain actions within the digital world. Many VR systems do not incorporate machine learning algorithms into VR application. However, machine learning algorithms may provide for faster and more efficient system response to user input. Thus there is a need for virtual reality applications utilizing deep-learning.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for improved object detection by a neural network. According to various embodiments, a method for recognizing interactions in a virtual reality system using a neural network is provided. The virtual reality system may utilize a simple RGB camera without using a depth camera. Two neural networks may be run simultaneously, one for recognizing and tracking fingers and the other for gesture recognition.

The one or more neural networks may comprise a convolution-nonlinearity step and a recurrent step. The convolution-nonlinearity step may comprise a convolution layer and a rectified linear layer. The convolution-nonlinearity step may comprise a plurality of convolution-nonlinearity layer pairs, each convolution-nonlinearity layer pair comprising a convolution layer followed by a rectified linear layer.

The method comprises a training mode and an inference mode. In the training mode, the method includes: passing a dataset into the neural network, and training the neural network to recognize the fingers of a training user and a gesture of interest. The dataset may comprise a random subset of a video with known gestures of interest and minimal bounding boxes drawn around the fingers of the training user. During the training mode, parameters in the neural network may be updated using a stochastic gradient descent. In the inference mode, the method includes passing a series of images into the neural network, and recognizing the fingers of the VR user and gestures of interests from the series of images. The series of images may be a virtual reality feed that includes the hands of a VR user.

In both the training mode and the inference mode, recognizing the fingers of a user may include drawing a minimal bounding box around each finger. Recognizing the fingers may include drawing minimal bounding boxes around only the finger tips and using context to determine which finger is which. Context may include other parts of the hand. After the fingers are recognized, the fingers are also tracked 235 from one image to another.

In another embodiment, a system for recognizing virtual reality interactions using a neural network is provided. The system includes one or more processors, memory, and one or more programs stored in the memory. The one or more programs comprise instructions to operate in a training mode and an inference mode. In the training mode, the one or more programs comprise instructions to: pass a dataset into the neural network; and train the neural network to recognize the fingers of a training user and a gesture of interest, wherein the neural network includes a convolution-nonlinearity step and a recurrent step. In the inference mode, the one or more programs comprise instructions to: pass a series of images into the neural network, wherein the series of images is a virtual reality feed that includes the hands of a VR user; and recognize the fingers of the VR user and gestures of interests from the series of images.

In yet another embodiment, a non-transitory computer readable medium is provided. The computer readable medium storing one or more programs comprise instructions to operate in a training mode and an inference mode. In the training mode, the one or more programs comprise instructions to: pass a dataset into the neural network; and train the neural network to recognize the fingers of a training user and a gesture of interest, wherein the neural network includes a convolution-nonlinearity step and a recurrent step. In the inference mode, the one or more programs comprise instructions to: pass a series of images into the neural network, wherein the series of images is a virtual reality feed that includes the hands of a VR user; and recognize the fingers of the VR user and gestures of interests from the series of images.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of virtual reality interaction using a neural network, in accordance with one or more embodiments.

FIGS. 2A, 2B, and 2C illustrate an example of a method for recognizing interactions in a virtual reality system using a neural network, in accordance with one or more embodiments.

FIG. 3 illustrates one example of a virtual reality neural network system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, a method for recognizing virtual reality interactions using a neural network is provided. The method comprises a training mode and an inference mode. In the training mode, the method includes: passing a dataset into the neural network; and training the neural network to recognize the fingers of a training user and a gesture of interest, wherein the neural network includes a convolution-nonlinearity step and a recurrent step. In the inference mode, the method includes: passing a series of images into the neural network, wherein the series of images is a virtual reality feed that includes the hands of a VR user; and recognizing the fingers of the VR user and gestures of interests from the series of images.

### Example Embodiments

In various embodiments, a system and method are provided for combining neural network based object detection and tracking with gesture recognition systems for use in user-interactions with a virtual reality application. Specifically, the system takes, as input, a video feed of a user's hands, and is able to track and understand a variety of movements and gestures. This understanding enables virtual reality applications to interact with a user's hand motions, in real-time, allowing the user to, for example, create drawings, make selections, and virtually interact with objects, along with many other applications.

In some embodiments, the system relies on neural networks to identify and perform tracking of the subjects finger(s). It also relies on a neural network to learn and detect various gestures. It combines these components to enable virtual reality applications. In various embodiments, one or more neural networks may be run simultaneously, for example, one for recognizing and tracking fingers and the other for gesture recognition. Gesture recognition may be may be performed by a gesture recognition neural network as described in the U.S. Patent Application entitled SYSTEM AND METHOD FOR IMPROVED GESTURE RECOGNITION USING NEURAL NETWORKS filed on Dec. 5, 2016 which claims priority to U.S. Provisional Application No. 62/263,600, filed on Dec. 4, 2015, of the same title, each of which are hereby incorporated by reference.

Objects, such as fingers, hands, arms, and/or faces may be identified by a neural network detection system as described in the U.S. Patent Application titled SYSTEM AND METHOD FOR IMPROVED GENERAL OBJECT DETECTION USING NEURAL NETWORKS filed on Nov. 30, 2016 which claims priority to U.S. Provisional Application No. 62/261,260, filed Nov. 30, 2015, of the same title, each of which are hereby incorporated by reference. Such objects may further be tracked from one image to the next in an image sequence by a tracking system as described in the U.S. Patent Application entitled SYSTEM AND METHOD FOR DEEP-LEARNING BASED OBJECT TRACKING filed on Dec. 2, 2016 which claims priority to U.S. Provisional Application No. 62/263,611, filed on Dec. 4, 2015, of the same title, each of which are hereby incorporated by reference. Additionally, distance and velocity of such objects may be estimated and/or determined by a position estimation system as described in the U.S. Patent Application entitled SYSTEM AND METHOD FOR IMPROVED DISTANCE ESTIMATION OF DETECTED OBJECTS filed on Dec. 5, 2016 which claims priority to U.S. Provisional Application No. 62/263,496, filed Dec. 4, 2015, of the same title, each of which are hereby incorporated by reference.

Object Detection/Tracking System

In some embodiments, one of the requirements for allowing users to interact with a virtual reality application using their hands is the ability to detect the location of a user's fingers within an image. To accomplish this, the system may utilize a neural network which is trained to detect a new object, such as the location of all the user's fingertips that are visible within the image. To do this, the system uses a labeled dataset which has a small box drawn around the fingertip of each finger within the image. Given such a dataset, the neural network may predict the location of the fingertips within each image and compare it to the labeled dataset. The parameters within the neural network may then be updated by a stochastic gradient descent. The result is a neural network which yields, in real-time, the location and size (within the image) of all the fingertips shown in the image. In some embodiments, such object detection may be may be performed by a neural network detection system as described in the U.S. Patent Application titled SYSTEM AND METHOD FOR IMPROVED GENERAL OBJECT DETECTION USING NEURAL NETWORKS, previously referenced above.

In various embodiments, a neural network may also be used to perform tracking of the fingertips across a sequence of image frames. In some embodiments, such tracking may be performed by a tracking system as described in the U.S. Patent Application entitled SYSTEM AND METHOD FOR DEEP-LEARNING BASED OBJECT TRACKING, previously referenced above. In some embodiments, a neural network may utilize a tracking system for tracking images of heads within a sequence of frames. In that case, the cropped images within the boxes contain sufficient information for the tracking system to determine which box belongs to which person within a sequence of frames, and therefore to track a person. However such an application may require a small modification to yield good accuracy for tracking fingertips. For the application of finger tracking, the box drawn only contains the fingertip itself, and therefore all the fingertips may look approximately the same. Therefore, instead of cropping the image to the box given by the detection system, the neural network may enlarge the box by a fixed factor. For example, the neural network may enlarge each box by a factor of five. The neural network may then use the information contained within the enlarged box for object tracking. Because the enlarged box may contains other fingers and other parts of the hand, the neural network algorithm may develop a context for which finger within the hand each box corresponds to, and therefore the tracking can be done accurately. The result of such a detection and tracking component is a set of locations and sizes of all the fingertips within the image, for a sequence of images.

Gesture Recognition System

In some embodiments, the second component of information fed into the system may utilize a gesture recognition system. In some embodiments, a gesture recognition system may comprise a neural network which is trained to detect when certain gestures occur within a sequence of images. In some embodiments, such gesture recognition may be may be performed by a gesture recognition neural network as described in the U.S. Patent Application entitled SYSTEM AND METHOD FOR IMPROVED GESTURE RECOGNITION USING NEURAL NETWORKS, previously referenced above. In some embodiments, the neural network may be trained to detect various hand gestures performed by a user for a virtual reality application. The hand gestures may include various “swipe” motions, “pressing” motions, and hand opening/closing motions, but may also be extended to other gestures. The neural network algorithm requires a labeled dataset of sequences of images, where for each image, all the gestures which are occurring in that image (in the context of the sequence) are tagged. For example, if a sequence contains a person's left and right hand, with one hand swiping left, and another hand swiping down, all the frames within the sequence for which the person is swiping should be tagged.

In some embodiments, the tagged dataset may be fed into the training procedure of the neural network, resulting in a “gesture detector” to which can be fed a video stream (i.e. a continuous sequence of images). The neural network may then tag all the images during which a sequence occurs in real time (with the exception of the first few frames within the sequence).

Combination and Application

In some embodiments, by combining the output from the previous two sections, the system may enable a suite of user interactions with a virtual reality system, utilizing only a simple, RGB camera (a depth camera is not necessary). The following Figures depict an example of tracking a person's index finger to allow drawing on a screen, while also detecting a “swipe right” gesture, indicating that the screen should be cleared. The system may run two neural networks simultaneously with one doing the detection and tracking, and another doing the gesture recognition.

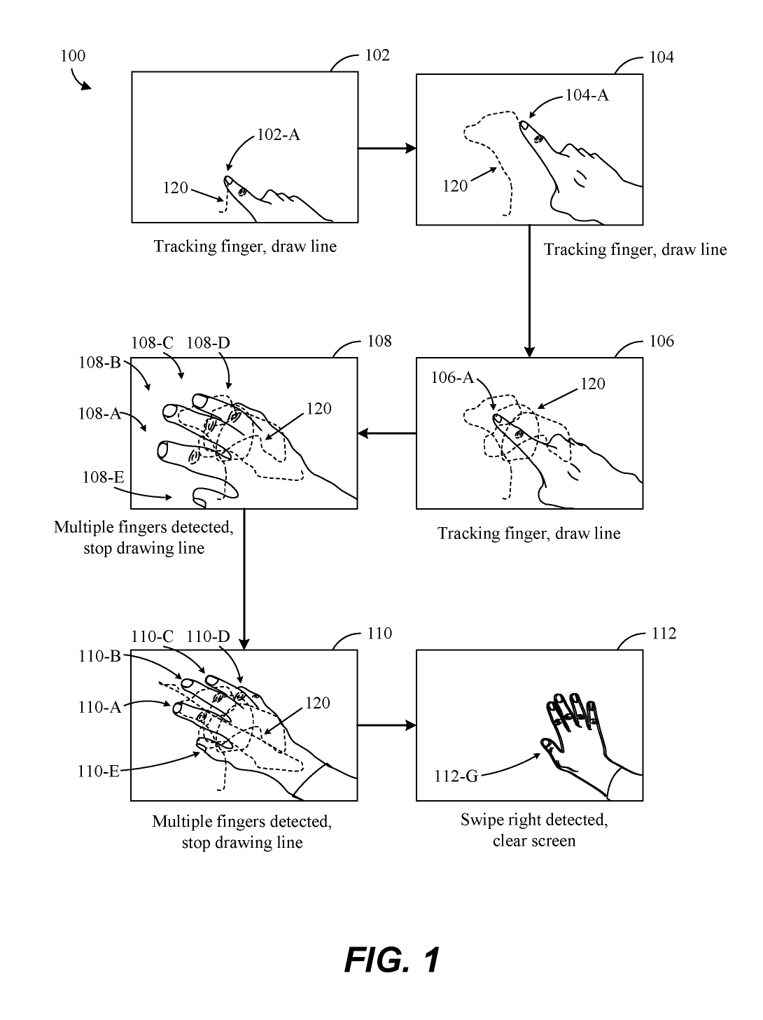

FIG. 1 illustrates a particular example of a system 100 for combining fingertip detection/tracking system and gesture recognition system in a virtual reality application. As shown in FIG. 1, a chronological sequence of images is shown, which may be images in a video sequence captured by a camera. The images include, in chronological order, images 102, 104, 106, 108, 110, and 112. Such images may be captured and/or displayed to a user as virtual reality (VR) and/or augmented reality (AR) at a viewing device, such as a virtual reality headset. In various embodiments, VR applications may simulate a user's physical presence in an environment and enable the user to interact with this space and any objects depicted therein. Images may also be presented to a user as augmented reality (AR), which is a live direct or indirect view of a physical, real-world environment whose elements are augmented (or supplemented) by computer-generated sensory input such as sound, video, graphics, or GPS data. When implemented in conjunction with systems and method described herein, such AR and/or VR applications may allow a user to alter and/or manipulate objects and/or scenes within captured images of the real-world environment.

The application depicted in FIG. 1 may be a drawing tool, which works by tracing the finger when only 1 finger is detected, and also clearing the screen when a swipe-right gesture is detected. A sequence of images are fed into system 100 one at a time. First, image 102 is fed into system 100. The detection/tracking system detects the only fingertip 102-A visible. As shown in FIG. 1, when a single fingertip is detected, the system 100 traces it on the screen using a line 120. As depicted in FIG. 1, line 120 is shown as a dashed line. However, in various embodiments, line 120 may be a solid line, and/or may comprise one or more colors and/or other characteristics. Image 102 may also be used as input in the gesture recognition system, but no swipe-right gesture is identified at this point. Image 104 is then fed as input into detection/tracking system, which again detects the single fingertip 104-A and continues to trace it, continuing to draw line 120 on the screen. Image 104 may also be used as input into the gesture recognition system, which, because this is no longer the initial frame in the sequence, also takes the feature tensor from the previous image frame 102. The gesture recognition again does not detect a swipe-right gesture performed. Next, image 106 is fed into the detection/tracking system, and a single fingertip 106-A is detected. Similarly, the drawing of line 120 on the screen by tracing the finger continues. Image 106, along with the feature tensor from the previous image 104 is fed into the gesture recognition system, which again detects that no swipe-right gesture is being performed.

Image 108 is then fed into the detection/tracking system. Here, five fingertips (108-A, 108-B, 108-C, 108-D, 108-E) are all detected. According to at least one aspect of this application, when multiple fingertips are detected, the detection/tracking system no longer draws on the screen. Therefore when this frame is detected and/or tracked, system 100 halts drawing line 120. Image 108 may also be fed into the gesture recognition system. As may be evident from image 108, it appears the hand is starting to make a swiping gesture. However, because this is the first frame of the gesture, the gesture system may be unable to clearly determine that a swipe-right is about to occur, and therefore correctly predicts that the current frame 108 has no swipe-right gesture being performed in it. Image 110 may then be fed into the detection/tracking system, which again detects five fingertips (110-A, 110-B, 110-C, 110-D, 110-E). Because more than one fingertip is detected, the system continues not to perform any drawing. The image 110 may also be fed into the gesture recognition system, along with the feature tensor from image 108. In some embodiments, it may still be too early for the system to fully determine that a swipe right gesture is being performed at this point, and therefore the system still assesses that during this frame, no swipe-right gesture is being performed. Image 112 is then fed into the detection/tracking system. The fingertips in image 112 are too small to be detected, and so no fingers are tracked or detected. Image 112 may also be fed into the gesture recognition system, along with the feature tensor from image 110. The gesture recognition is able to detect that the swipe-right gesture is being performed in this frame (in the context of the previous frames), and it classifies that the swipe-right gesture 112-G occurs. The system then takes the information that a swipe-right gesture 112-G was performed and clears the screen of the drawing.

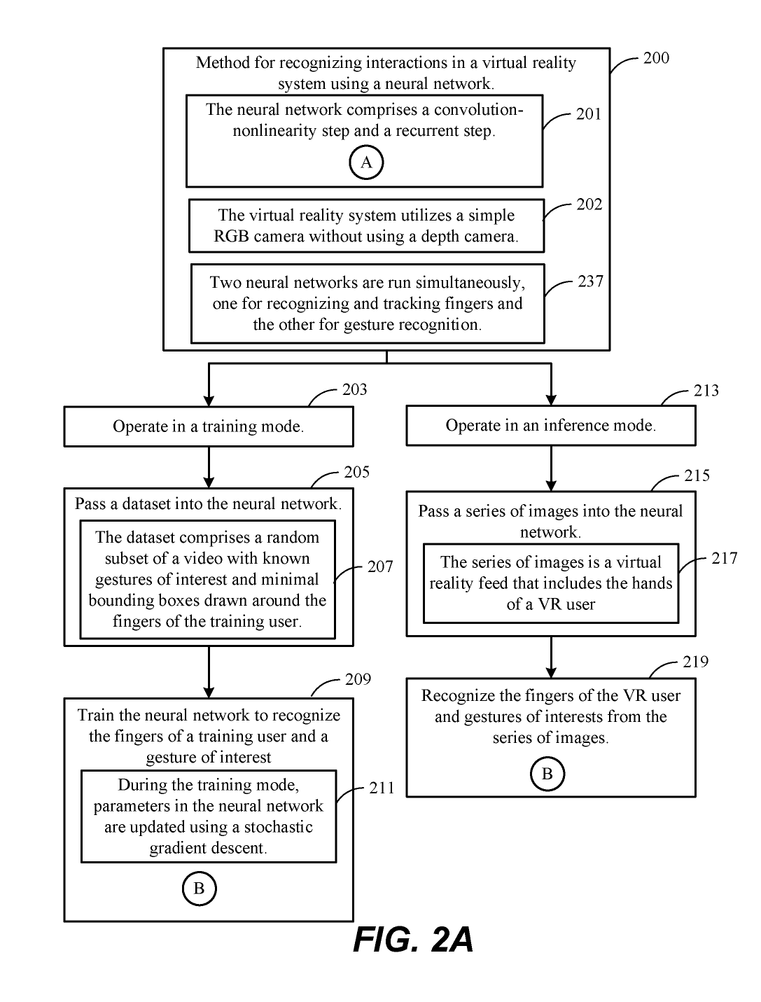

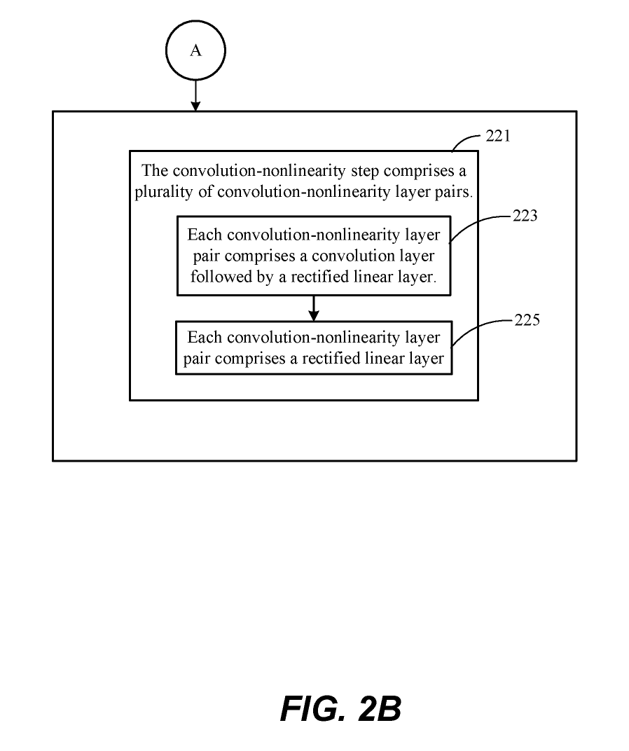

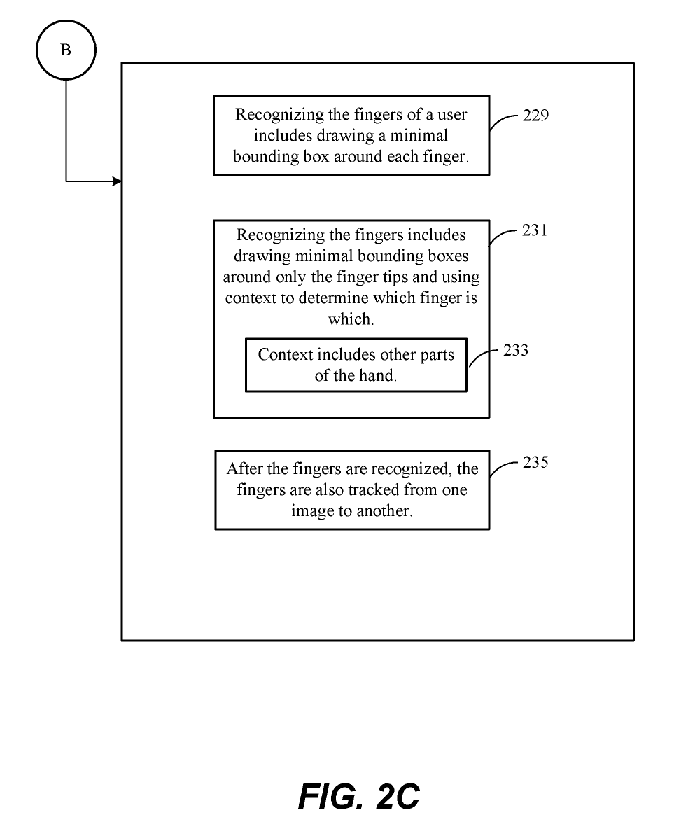

FIGS. 2A, 2B, and 2C illustrate an example of a method 200 for interactions in a virtual reality system using a neural network 201, in accordance with one or more embodiments. In some embodiments, neural network 201 may be a neural network implemented in system 100. In some embodiments, the neural network may comprise a convolution-nonlinearity step and a recurrent step. In some embodiments neural network 201 may comprise multiple convolution-nonlinearity steps 201. FIG. 2B illustrates an example of a convolution-nonlinearity step of method 200, in accordance with one or more embodiments. In various embodiments, the convolution-nonlinearity step comprises a convolution layer 223 and a rectified linear layer 225. In some embodiments, the convolution-nonlinearity step may comprise a plurality of convolution-nonlinearity layer pairs 221. Each convolution-nonlinearity layer pair may comprise a convolution layer 223 followed by a rectified linear layer 225. In some embodiments, neural network 201 may include any number of convolution-nonlinearity layer pairs. In some embodiments, a neural network may include only one convolution-nonlinearity layer pair 221.

Neural network 201 may operate in a training mode 203 and an inference mode 213. When operating in the training mode 203, a dataset is passed into the neural network at 205. In some embodiments, the dataset may comprise a random subset 207 of a video with known gestures of interest and minimal bounding boxes drawn around the fingers of the training user. In some embodiments, such minimal bounding boxes may be predetermined and manually drawn around the fingers, such as by a user of the system 100. However, in various embodiments, such minimal bounding boxes may be output by the neural network detection system described in the U.S. Patent Application titled SYSTEM AND METHOD FOR IMPROVED GENERAL OBJECT DETECTION USING NEURAL NETWORKS, previously referenced above. The minimal bounding boxes drawn around the fingers may be drawn around the fingers of the training user in each image in the dataset by object tracking. In various embodiments, such tracking may be performed by a tracking system as described in the U.S. Patent Application entitled SYSTEM AND METHOD FOR DEEP-LEARNING BASED OBJECT TRACKING, previously referenced above. In some embodiments, passing the dataset into the neural network may comprise inputting the pixels of each image in the dataset as third-order tensors into a plurality of computational layers as described in FIG. 2B.

At 209, the neural network is trained to recognize the fingers of a training user and a gesture of interest. During the training mode 203 in certain embodiments, parameters in the neural network may be updated using a stochastic gradient descent 211. In some embodiments, a neural network may be trained until the neural network recognizes fingers and gestures at a predefined threshold accuracy rate. In various embodiments, the specific value of the predefined threshold may vary and may be dependent on various applications.

Once the neural network is deemed to be sufficiently trained, the neural network may be used to operate in the inference mode 213. When operating in the inference mode 213, a series of images 217 is passed into the neural network at 215. In various embodiments, such images 217 may be captured by a camera in the virtual reality system. In some embodiments, the virtual reality system utilizes a simple RGB camera 202 without using a depth camera. In some embodiments, the series of images 217 may be a virtual reality feed that includes the hands of a VR user. In some embodiments, the pixels of the series of images 217 are input into the neural network as third-order tensors. In some embodiments, the image pixels are input into a plurality of computational layers within convolution-nonlinearity step 201 as described in step 205.

At 219, the neural network recognizes the fingers of the VR user and gestures of interests from the series of images. In both training mode 203 and inference mode 213, the neural network may recognize the finger of a user. In some embodiments, recognizing the fingers of a user may include drawing a minimal bounding box 229 around each finger. In further embodiments, recognizing the fingers may include drawing minimal bounding boxes around only the finger tips and using context 233 to determine which finger is which. In some embodiments, context 233 may include other parts of the hand. In other embodiments, after the fingers are recognized, the fingers are also tracked 235 from one image to another.

In some embodiments, two neural networks are run simultaneously, one for recognizing and tracking fingers and the other for gesture recognition. As previously described, minimal bounding boxes may be output around an object, such as a finger and/or hand, by the neural network detection system described in the U.S. Patent Application titled SYSTEM AND METHOD FOR IMPROVED GENERAL OBJECT DETECTION USING NEURAL NETWORKS, previously referenced above. Furthermore, such objects may be tracked from one image frame to the next in a series of images 217 by a tracking system as described in the U.S. Patent Application entitled SYSTEM AND METHOD FOR DEEP-LEARNING BASED OBJECT TRACKING, previously referenced above. Furthermore, gesture recognition may be may be performed by a gesture recognition neural network as described in the U.S. Patent Application entitled SYSTEM AND METHOD FOR IMPROVED GESTURE RECOGNITION USING NEURAL NETWORKS, previously referenced above.

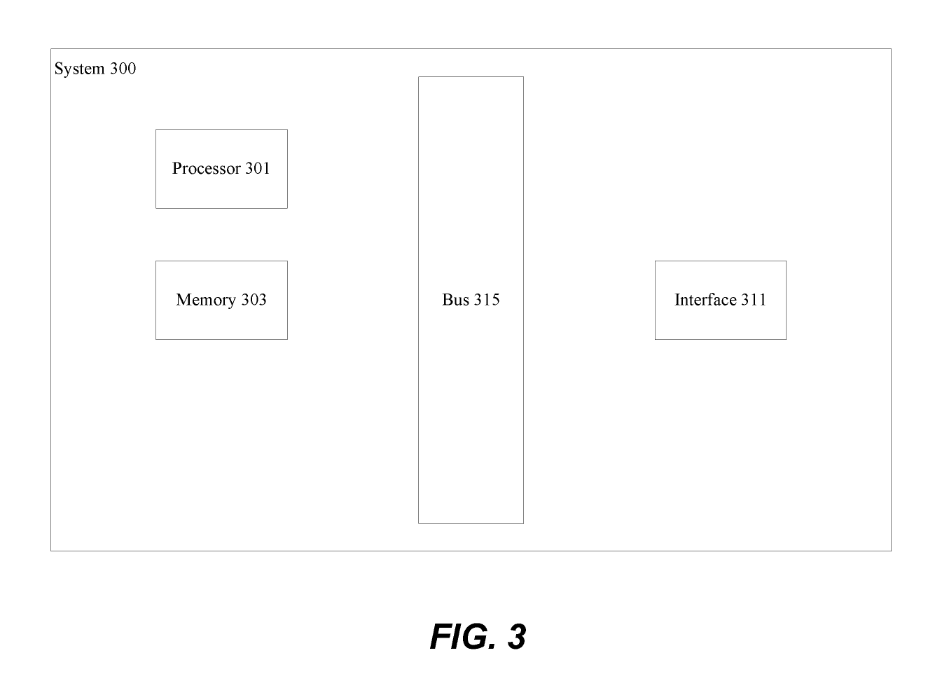

FIG. 3 illustrates one example of a neural network system 300, in accordance with one or more embodiments. According to particular embodiments, a system 300, suitable for implementing particular embodiments of the present disclosure, includes a processor 301, a memory 303, an interface 311, and a bus 315 (e.g., a PCI bus or other interconnection fabric) and operates as a streaming server. In some embodiments, when acting under the control of appropriate software or firmware, the processor 301 is responsible for various processes, including processing inputs through various computational layers and algorithms. Various specially configured devices can also be used in place of a processor 301 or in addition to processor 301. The interface 311 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 300 uses memory 303 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for recognizing interactions in a virtual reality system using a neural network, the method comprising:
in a training mode:
passing a dataset into the neural network;
training the neural network to recognize the fingers of a training user and a gesture of interest, wherein the neural network includes a convolution-nonlinearity step and a recurrent step;
in an inference mode:
passing a series of images into the neural network, wherein the series of images is a virtual reality feed that includes the hands of a VR user;
recognizing the fingers of the VR user and gestures of interests from the series of images.

2. The method of claim 1, wherein the dataset comprises a random subset of a video with known gestures of interest and minimal bounding boxes drawn around the fingers of the training user.

3. The method of claim 1, wherein the convolution-nonlinearity step comprises a convolution layer and a rectified linear layer.

4. The method of claim 1, wherein the convolution-nonlinearity step comprises a plurality of convolution-nonlinearity layer pairs, each convolution-nonlinearity layer pair comprising a convolution layer followed by a rectified linear layer.

5. The method of claim 1, wherein recognizing the fingers of a user includes drawing a minimal bounding box around each finger.

6. The method of claim 1, wherein after the fingers are recognized, the fingers are also tracked from one image to another.

7. The method of claim 1, wherein the virtual reality system utilizes a simple RGB camera without using a depth camera.

8. The method of claim 1, wherein recognizing the fingers includes drawing minimal bounding boxes around only the fingertips and using context to determine which finger is which, wherein context includes other parts of the hand.

9. The method of claim 1, wherein two neural networks are run simultaneously, one for recognizing and tracking fingers and the other for gesture recognition.

10. The method of claim 1, wherein, during the training mode, parameters in the neural network are updated using a stochastic gradient descent.

11. A virtual reality system using a neural network for user interactions, comprising:
a camera;
a virtual reality interface;
one or more processors;
memory; and
one or more programs stored in the memory, the one or more programs comprising instructions to operate in a training mode and an inference mode;
wherein in the training mode, the one or more programs comprise instructions for:
passing a dataset into the neural network;
training the neural network to recognize the fingers of a training user and a gesture of interest, wherein the neural network includes a convolution-nonlinearity step and a recurrent step;
wherein in the inference mode, the one or more programs comprise instructions for:
passing a series of images into the neural network, wherein the series of image is a virtual reality feed that includes the hands of a VR user;
recognizing the fingers of the VR user and gestures of interests from the series of images.

12. The system of claim 11, wherein the dataset comprises a random subset of a video with known gestures of interest and minimal bounding boxes drawn around the fingers of the training user.

13. The system of claim 11, wherein the convolution-nonlinearity step comprises a convolution layer and a rectified linear layer.

14. The system of claim 11, wherein the convolution-nonlinearity step comprises a plurality of convolution-nonlinearity layer pairs, each convolution-nonlinearity layer pair comprising a convolution layer followed by a rectified linear layer.

15. The system of claim 11, wherein recognizing the fingers of a user includes drawing a minimal bounding box around each finger.

16. The system of claim 11, wherein after the fingers are recognized, the fingers are also tracked from one image to another.

17. The system of claim 11, wherein the camera comprises a simple RGB camera and the virtual reality system does not use a depth camera.

18. The system of claim 11, wherein recognizing the fingers includes drawing minimal bounding boxes around only the fingertips and using context to determine which finger is which, wherein context includes other parts of the hand.

19. The system of claim 11, wherein two neural networks are run simultaneously, one for recognizing and tracking fingers and the other for gesture recognition.

20. A non-transitory computer readable storage medium storing one or more programs configured for execution by a computer, the one or more programs comprising instructions to operate in a training mode and an inference mode;
wherein in the training mode, the one or more programs comprise instructions for:
passing a dataset into the neural network;
training the neural network to recognize the fingers of a training user and a gesture of interest, wherein the neural network includes a convolution-nonlinearity step and a recurrent step;
wherein in the inference mode, the one or more programs comprise instructions for:
passing a series of images into the neural network, wherein the series of image is a virtual reality feed that includes the hands of a VR user;
recognizing the fingers of the VR user and gestures of interests from the series of images.
